(19) United States
(12) Patent Application Publication
(10) Pub. No.: US 2008/0297949 A1
(43) Pub. Date: Dec. 4, 2008

(54) Head slider

(75) Inventors: Irizo Naniwa, Fujisawa (JP); Junguo Xu, Kasumigaura (JP); Ryuji Tsuchiyama, Matsudo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd

(21) Appl. No.: 12/155,039

(22) Filed: May 29, 2008

(30) Foreign Application Priority Data
Jun. 1, 2007 (JP) 2007-146431

(51) Int. Cl. G11B 5/56

(52) U.S. Cl. 360/294.4

(57) ABSTRACT

When a piezoelectric element is deformed in the direction of decreasing a flying height, a pressure at a trailing pad increases, and the flying height of a magnetic head is not efficiently decreased and may be increased conversely in some occasions.

A position of contact between a suspension and a dimple is set toward a leading edge with respect to a piezoelectric element, and a pad for generating a positive pressure is disposed between the dimple and the piezoelectric element in addition to a trailing pad. Fluctuations of a positive pressure generated toward the leading edge with respect to the dimple are thus suppressed when the piezoelectric element is deformed.

### CLAIM OF PRIORITY

The present application claims priority from Japanese application serial no. P2007-146431, filed on Jun. 1, 2007, the content of which is hereby incorporated by reference into this application.

### BACKGROUND OF THE INVENTION

1. Field of the Invention

The present invention relates to a head slider used in a disk apparatus and, more particularly, to an active slider. An active slider is a slider having an actuator for moving a head in any of a flying direction, a track direction, and a jitter direction.

2. Description of the Related Art

Actuators for moving a head in a flying direction in practical use include those which include a heater formed in a slider and in which a write/read element portion is protruded by thermal expansion caused by the heater serving as a heat source to vary the flying height of the write/read element.

Active sliders capable of dynamically following up a waviness of a disk and capable of accurate positioning in the direction of a data track using a piezoelectric element as an actuator have been introduced at academic meeting and the like. In particular, the invention disclosed in JP-A-2000-348321 is a well-known technique relating to an active slider which has high rigidity and which is excellent in the reliability of bonding between a piezoelectric material and a slider base material.

In the active slider disclosed in JP-A-2000-348321, a magnetic head is mounted on a slider base material with a piezoelectric element interposed therebetween, and the piezoelectric element is displaced to adjust the position of the magnetic head minutely. The active slider disclosed in JP-A-2000-348321 serves as a flying height control actuator which allows the magnetic head to fly at an extremely small height when it moves the head in the direction of the flying height. When the slider moves the head in the direction of the width of a track, it serves as an actuator having high positioning accuracy. When the slider moves the head in the circumferential direction of a track, it serves as an actuator for reducing jitters of a reproduction signal. The active slider disclosed in JP-A-2000-348321 can achieve high-speed response because it moves the magnetic head using only the deformation of the piezoelectric element itself. Further, since the bonding surface of the slider base material undergoes no deformation, the slider has high reliability of bonding.

JP-A-2002-251855 discloses an invention in which an actuator is provided on a side of a slider and in which a magnetic head portion is separated from a slider base material and driven by the actuator.

However, the above-described techniques in the related art have problems as described below.

FIG. 16 is an illustration showing a problem which occurs when an actuator 3′ subject to shear deformation is sandwiched by a slider. The attitude of the actuator is determined by the balance among a pressing force 14 applied by a dimple 10, a positive pressure 15 and a negative pressure 16 generated at an air bearing surface of a slider base material 4, and a positive pressure 17 generated at an air bearing surface of a head portion 2. When the actuator 3′ is deformed in the direction of decreasing the flying height of a head (write/read element) provided at a head portion 2, the positive pressure 17 that is generated at a pad of the head portion 2 increases. Then, a flying height 18 of the head portion increases, and a pitch angle 19 decreases. As a result, the head flying height 18 is not decreased efficiently in relation to the amount of deformation of the actuator 3′. The flying height of the head portion 2 can increase contrary to the intention depending on the balance between the increase in the positive pressure 17 and a decrease in the positive pressure 15 attributable to the decrease in the pitch angle 19. In particular, when the pitch angle decreases to a minus angle, a positive pressure generated by the slider as a whole remarkably decreases, which can adversely affect flyability of the slider.

When the head portion 2 is used for control in the direction of a track, the deformation of the actuator 3′ results in an offset between center axes of the slider base material 4 and the head portion 2 in the longitudinal direction of the slider. As a result of this offset, the positive pressure 17 generated on the downstream side of the actuator 3′ will be also offset from the center axis. Then, the slider receives a force in the roll direction, and flyability of the same is therefore adversely affected.

Another problem is how to assemble the piezoelectric element in the gap between the slider base material and the head without making a significant change in existing slider manufacturing processes. For example, when the actuator utilizes a shear deformation mode of the piezoelectric element, the polarization direction and the direction of the electric field must be made orthogonal, and the electrode surface (bonding surface) of the piezoelectric element and the polarization direction must be in parallel with each other. However, in order to dispose the piezoelectric element in such a manner, an electrode for polarization and an electrode for driving must be provided on respective different surfaces of the piezoelectric element. Further, when the slider has a shape that is totally different from normal slider shapes, significant changes must be made in manufacturing processes themselves.

### SUMMARY OF THE INVENTION

The invention provides an active slider in which the flying height of a head may be efficiently changed or an active slider which may be manufactured without significant changes in slider manufacturing processes.

The invention of the present request includes a configuration and a manufacturing method as described below.

A head slider includes a slider base material which receives a pre-load from a suspension, a deforming element bonded to the slider base material, and a head portion bonded to the slider base material through the deforming element. The slider includes a pad generating a positive pressure on an air bearing surface of the slider base material which is located toward the deforming element with respect to the position receiving the load. The attitude of the slider is maintained by balance between a positive pressure generated at the pad located toward a leading edge side with respect to the deforming element and a pressing force from a dimple.

Alternatively, the slider includes a head portion having an element for writing and reading information on and from a recording medium, a deforming element located on an air leading side of the head portion, and a slider base material located on the air leading side of the deforming element. The slider includes a first positive pressure generating surface provided on an air bearing surface which is located toward the air leading side with respect to the position at ⅓ of the entire length of the head slider from the air leading side and a second positive pressure generating surface provided on the air bearing surface in a position which is located toward the air trailing side with respect to the position at ⅓ of the entire length of the head slider from the air leading side and which is located toward the air leading side with respect to the deforming element.

A metal is vacuum-deposited on a surface of a first wafer. A write/read element is formed on a surface of a second wafer, and a metal is vacuum-deposited on another surface of the same. A metal is vacuum-deposited on both surfaces of a plate material to serve as a deforming element. The first wafer and the second wafer are bonded with the plate material sandwiched between the surfaces thereof on which the metals are vacuum-deposited. A head slider is manufactured by cutting the bonded member.

According to the invention of the present request, a change in a flying height may be efficiently obtained from deformation of an actuator. The attitude of the slider may be prevented from becoming unstable even when a magnetic head is moved by deformation of the actuator.

An active slider may be manufactured without significant changes in existing slider manufacturing processes.

### BRIEF DESCRIPTION OF THE DRAWINGS

FIG. 1 is an exemplary perspective view showing the interior of a magnetic disk apparatus employing the invention.

FIGS. 2A, 2B and 2C are an exemplary illustration showing a configuration and a principle of an active slider according to the invention.

FIG. 3 is an exemplary perspective view showing an air bearing surface of a slider of Embodiment 1 of the invention.

FIG. 4 is illustration showing forces acting on the slider of Embodiment 1 of the invention.

FIG. 5 is an exemplary graph showing a difference between changes in a flying height which occur depending on whether a step is provided at a trailing pad or not.

FIGS. 6A and 6B are an exemplary graph showing a difference between pressure distributions on an air bearing surface which occur depending on whether a step is provided at a trailing pad or not.

FIG. 7 is an exemplary graph showing a relationship between the distance between an air bearing surface of a trailing pad and a step and a pressure generated at the trailing pad.

FIG. 8 is an exemplary graph showing changes in a flying height in a case where three pads are formed on a slider base material and in a case where four pads are formed.

FIG. 9 is an exemplary perspective view showing an air bearing surface of a slider of Embodiment 2 of the invention.

FIG. 10 is an exemplary illustration showing forces acting on the slider of Embodiment 2 of the invention.

FIG. 11 is an exemplary graph showing flying heights and pitch angles relative to amounts of deformation of a piezoelectric element of Embodiment 2.

FIG. 12 is an exemplary sectional view showing Embodiment 3 of the invention.

FIG. 13 is a perspective view showing an air bearing surface of a slider of Embodiment 4 of the invention.

FIG. 14 is an exemplary illustration showing a method of manufacturing an active slider according to the invention.

FIG. 15 shows frequency response function of the active slider of Embodiment 4.

FIG. 16 is an exemplary illustration showing forces acting on an existing slider when a piezoelectric element is incorporated in the slider.

### DESCRIPTION OF THE PREFERRED EMBODIMENTS

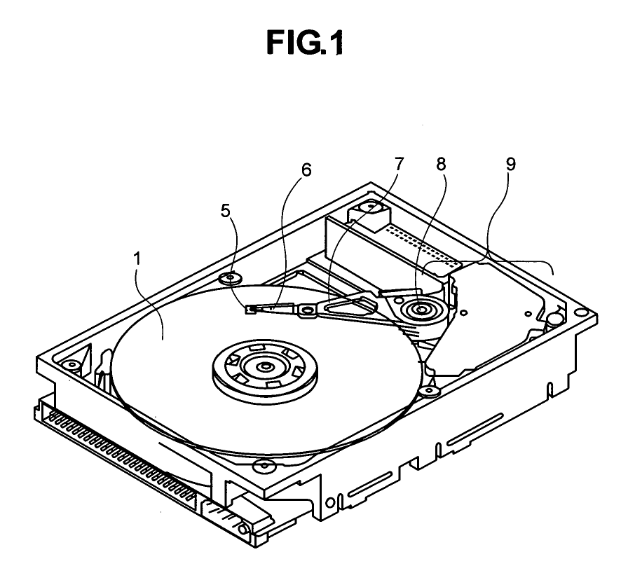

A magnetic disk apparatus will now be described as an example of a disk apparatus in which an active slider according to the invention is used. FIG. 1 is a perspective view of the magnetic disk apparatus. A disk 1 is a recording medium which is supported such that it may be rotated by a spindle motor. An active slider 5 having a magnetic head portion flies above a recording surface of the disk 1 at a predetermined interval from the same. The active slider 5 is supported by a suspension 6, and the suspension 6 is supported by a carriage 7. The carriage 7 is supported such that it may be swung around a pivot 8 as an axis of rotation. The carriage 7 is swung by driving a voice coil motor (VCM) 9, and a write/read element attached to the magnetic head portion is moved onto a desired track of the rotating disk 1 to write and/or read information on and/or from the disk 1.

The disk 1 rotates counter clockwise when it is viewed from above in FIG. 1, and the air in the gap between the disk 1 and the active slider 5 flows in the same direction as that of a rotational flow excited by the disk.

Embodiments of the invention will now be described based on the drawings.

### Embodiment 1

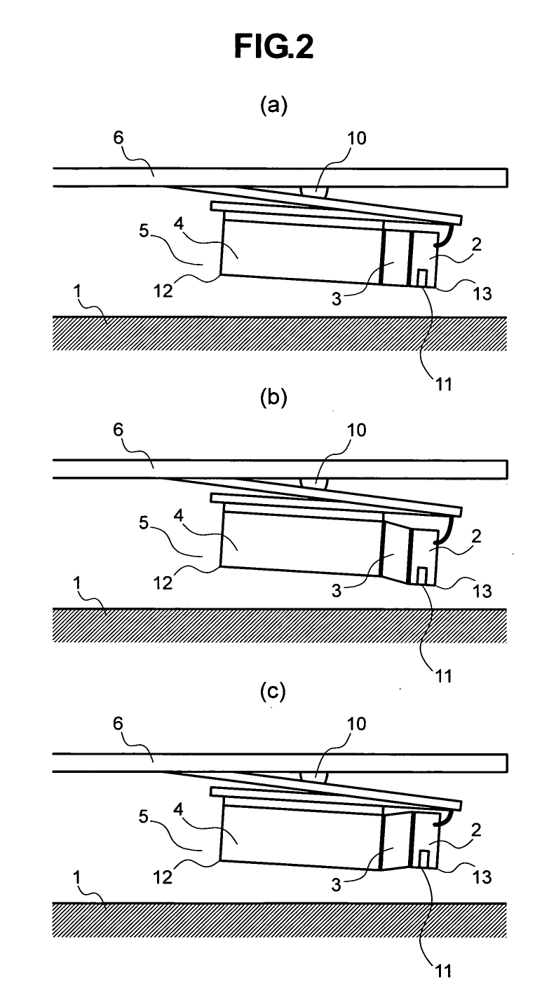

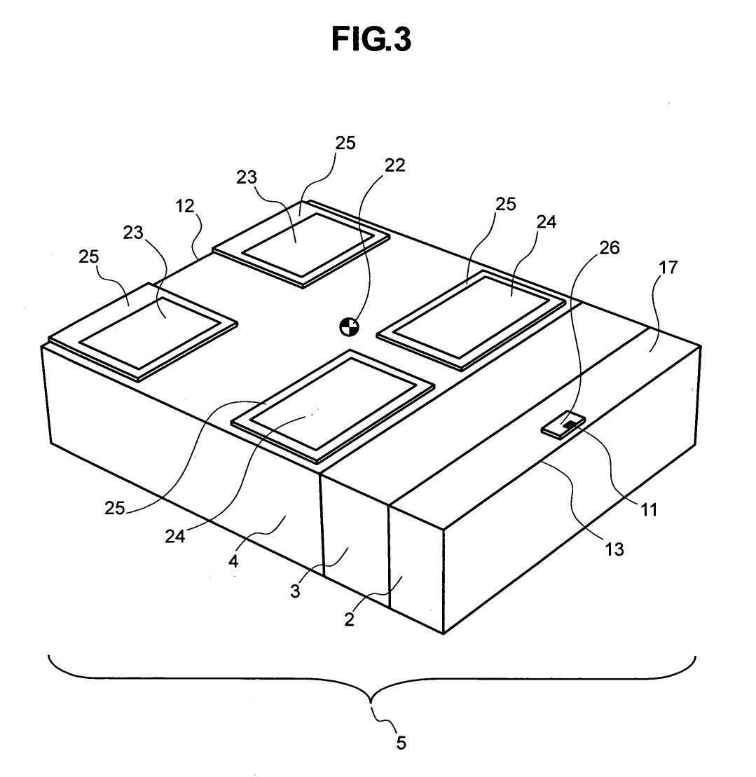

FIGS. 2A to 2C illustrations showing a configuration and a principle of an active slider according to a first embodiment of the invention. An active slider 5 flies above a recording surface of a disk 1 at a predetermined interval from the same, the slider including a head portion 2 having a write/read element 11 for writing and/or reading on and/or from a disk 1, a piezoelectric element 3 which is a deforming element subject to shear deformation used as an actuator, and a slider base material 4. The active slider 5 receives a load from a suspension 6 through a dimple 10 in the direction of pressing it against the disk 1. The position where the active slider 5 receives the load is at a distance equivalent to ⅓ to ½ of the entire length of the active slider from an air leading edge 12 thereof. The disk 1 rotates in the direction from the leading edge 12 of the active slider 5 to a trailing edge 13 of the same.

FIG. 2A shows a state in which the piezoelectric element 3 is not deformed. FIG. 2B shows a state in which the magnetic head portion 2 has been moved in the direction of decreasing the flying height of the write/read element 11 as a result of deformation of the piezoelectric element 3. FIG. 2C shows a state in which the magnetic head portion 2 has been moved in the direction of increasing the flying height of the write/read element 11 as a result of deformation of the piezoelectric element 3. The piezoelectric element 3 is deformed as shown to allow the write/read element 11 to be displaced independently of the slider base material 4.

FIG. 3 is a perspective view showing an example of an air bearing surface of the active slider 5 of the present embodiment. The active slider of the present embodiment has four pads in total disposed on the air bearing surface of the slider base material 4 to generate positive pressures, i.e., two pads 23 arranged in the width direction of the slider between a dimple position 22 which is the position of the point of contact of the dimple 10 transferring the load from the suspension to the slider projected in the thickness direction of the slider base material 4 and two pads 24 arranged in the width direction between the dimple position 22 and the piezoelectric element 3. Each of the pads has steps 25 on a leading side and a trailing side thereof.

One trailing pad 26 including the write/read element 11 is formed on the air bearing surface of the magnetic head portion 2. In order to prevent the generation of a positive pressure, no step (shallow groove on the air leading side) is provided on the trailing pad 26, and the pad has a size that is a required minimum to form the write/read element 11.

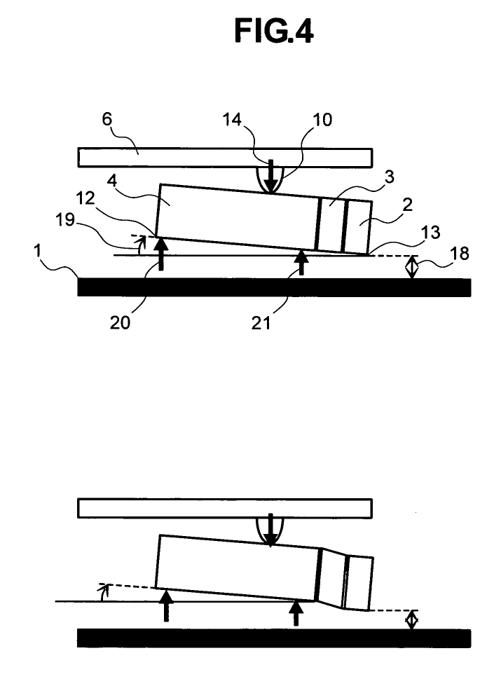

FIG. 4 is an illustration showing balance between forces applied to the active slider of Embodiment 1. The attitude of the slider in the pitching direction is determined by balance between a pressing force 14 from the dimple 10, a positive pressure 20 generated by the pads 23 (see FIG. 3), and a positive pressure 21 generated by the pads 24 (see FIG. 3). In the present embodiment, the pads 24 generate a major part of a positive pressure generated toward the trailing edge 13 with respect to the dimple 10 (Strictly speaking, the dimple position on the air bearing surface from the leading edge of the slider is offset from the position of the dimple 10 on the suspension at a pitch angle 19. However, the pitch angle 19 is small enough to regard those positions substantially the same.) The piezoelectric element 3 is deformed with a positive pressure generated at the head portion 2 made relatively small, which allows a change in the positive pressure generated toward the trailing edge with respect to the dimple position 22 to be suppressed even if there are increases in the pitch angle 19 of the trailing pad 26 and in the positive pressure generated at the trailing pad 26. Thus, a flying height 18 of the magnetic head portion 2 and the write/read element 11 may be efficiently reduced in relation to the amount of deformation of the piezoelectric element 3.

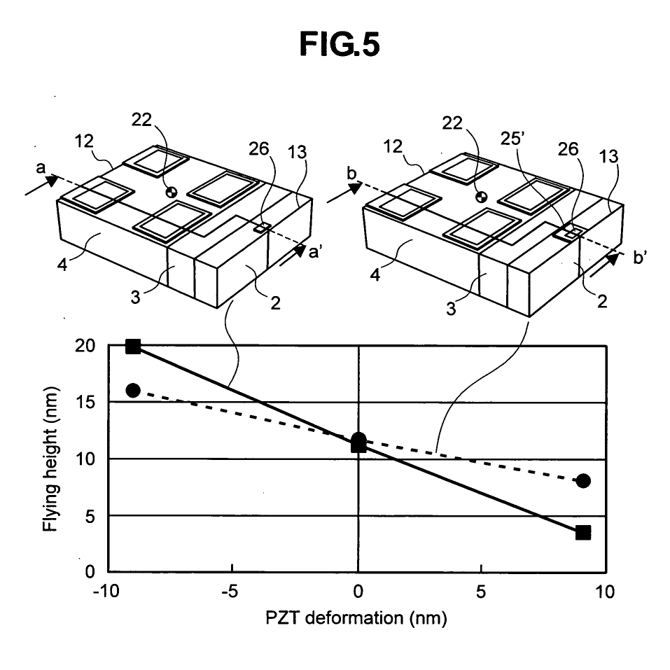

Although no step is provided at the trailing pad 26 in FIG. 4, the trailing pad 26 may have a step as long as it has the configuration including the pads 24 located toward the trailing edge with respect to the dimple position 22 to generate a major part of the positive pressure toward the trailing edge with respect to the dimple position. FIG. 5 is a graph showing changes in the flying height of the magnetic head portion 2 in relation to the deformation of the piezoelectric element 3 in a case where the trailing pad 26 has the step 25 and in a case where the step is not provided. The broken line indicates a relationship between the amount of deformation of the piezoelectric element 3 and the flying height in the case where the trailing pad 26 has the step 25, and the solid line indicates such a relationship in the case where the trailing pad 26 does not have the step 25.

FIG. 5 indicates that the provision of the pad 24 allows the flying height of the magnetic head 11 to be decreased by the deformation of the piezoelectric element 3 even when a step 25′ is provided on the trailing pad 26. It will be also understood that the flying height 18 of the write/read element of the magnetic head portion 2 is more efficiently decreased in relation to the amount of deformation of the piezoelectric element 3 in the case where the step 25 is not provided.

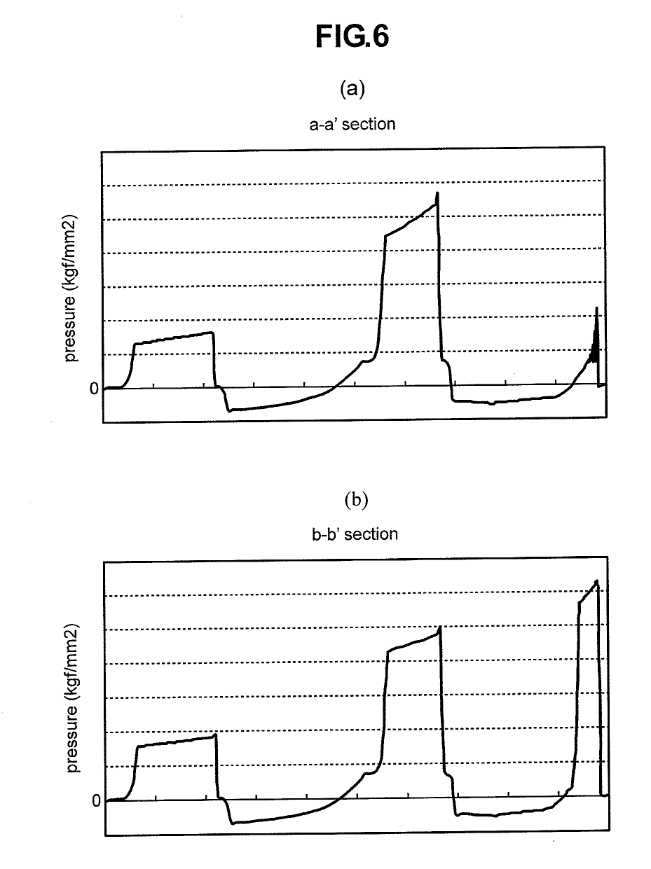

FIG. 6A shows a pressure distribution on a section a-a′ (a section passing through the pads generating a positive pressure) of the active slider in the case where the step 25′ is not provided on the trailing pad 26 as shown in FIG. 5. FIG. 6B shows a normalized pressure distribution on a section b-b′ of the active slider in the case where the step 25′ is provided on the trailing pad 26. In those figures, the horizontal axes represent the length of the slider from the air leading side to the trailing side, and the vertical axes represent a pressure generated at each position in a normalized form. Positive pressures are generated by a pad on the side of the leading end (corresponding to the pad 23 in FIG. 3), a pad provided on a leading side of the piezoelectric element 3 (corroding to the pad 24 in FIG. 3), and the trailing pad 26 which has the magnetic head 11.

A comparison between FIGS. 6A and 6B indicates that a smaller positive pressure is generated by the trailing pad 26 in the case where the step 25′ is not provided on the trailing pad 26. That is, the flying height 18 of the write/read element may be more efficiently decreased in the case wherein the step 25′ is not provided because deformation of the piezoelectric element 3 results in smaller changes in the total positive pressure generated toward the trailing edge 12 with respect to the dimple position 22.

Therefore, when the step 25′ is provided, it is desirable to make the surface area of the trailing pad 26 as small as possible and to provide a great gap between the air bearing surface of the trailing pad 26 and the step 25′ or a great depth of the step 25′ as will be described later, which allows the pressure generated at the trailing pad 26 to be suppressed and allows a moment of the positive pressure generated by the trailing pad 26 acting around the dimple to be kept as small as possible. Thus, the flying height 18 of the write/read element maybe efficiently decreased as a result of deformation of the piezoelectric element 3. Since balance between moments of the slider as a whole acting around the dimple varies depending on whether the step 25′ is provided or not, the balance between all moments may be maintained increasing the positive pressure generated at the pad located toward the leading side with respect to the dimple when the step 25′ is provided. When the dimple 25′ is not provided, since a smaller positive pressure is generated by the slider as a whole, the positive pressure generated may be adjusted by changing the surface area of the pad.

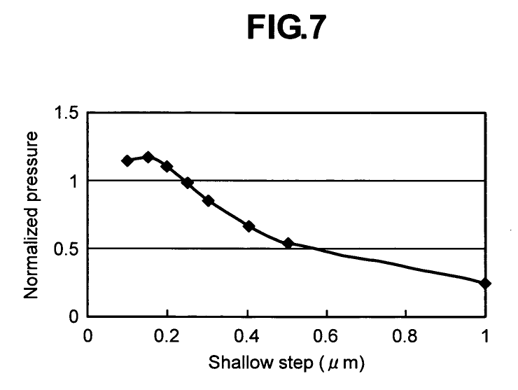

FIG. 7 is a graph showing a relationship between the gap between the air bearing surface of the trailing pad 26 and the step 25′ (the depth from the air bearing surface of the trailing pad 26 to the step 25′) produced when the piezoelectric element 3 is deformed in the direction of decreasing the flying height 18 of the magnetic head portion 2 by a certain amount and the pressure generated at the trailing pad 26 in a normalized form. Since the vertical axis of the graph represents normalized pressures, the absolute value of a value along the vertical axis depends on the shape of the slider and the flow rate. However, the shape of the graph does not depend on them. FIG. 7 indicates that the pressure generated at the trailing pad 26 peaks when the gap between the air bearing surface of the trailing pad 26 and the step 25′ is about 0.15 μm and decreases as the gap increases beyond that point. The figure shows that the generated pressure is small when the depth of the step 25′ is greater than 0.25 μm. Therefore, when the step 25′ is provided on the trailing pad 26, it is desirable to provide the step with a depth greater than 0.25 μm.

In the present embodiment, the slider base material 4 has four pads in total disposed thereon, i.e., two each in respective intervals between the leading edge 12 and the dimple position 22 and between the dimple position 22 and the piezoelectric element 3. However, what is intended is to generate the positive pressure toward the trailing edge 13 with respect to the dimple position 22 primarily in the interval between the dimple position 22 and the piezoelectric element 3. Although the positive pressure depends on the position and size of pads or the presence or absence of a step, it does not depend on the number of pads. Therefore, no problem occurs whether the number of the pads 23 and 24 is one or three or more.

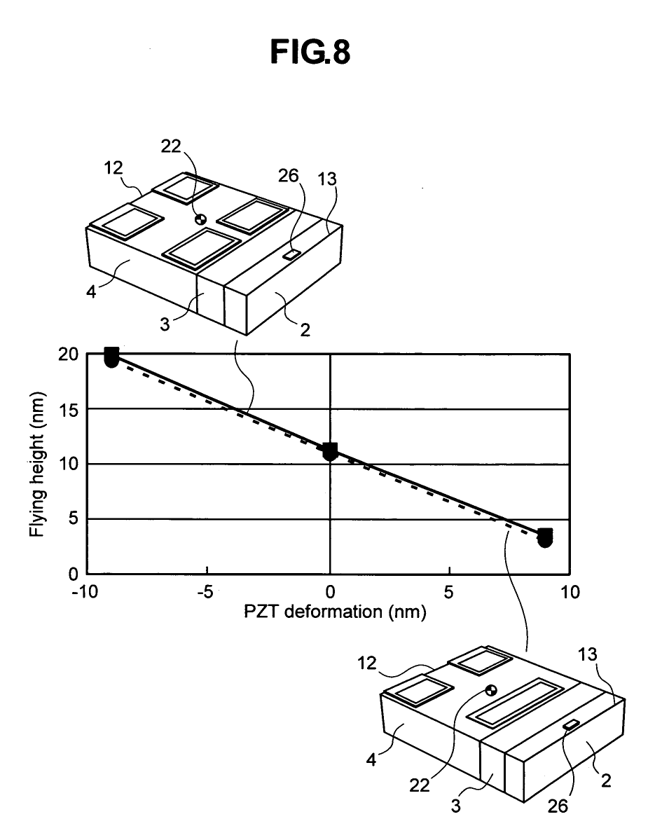

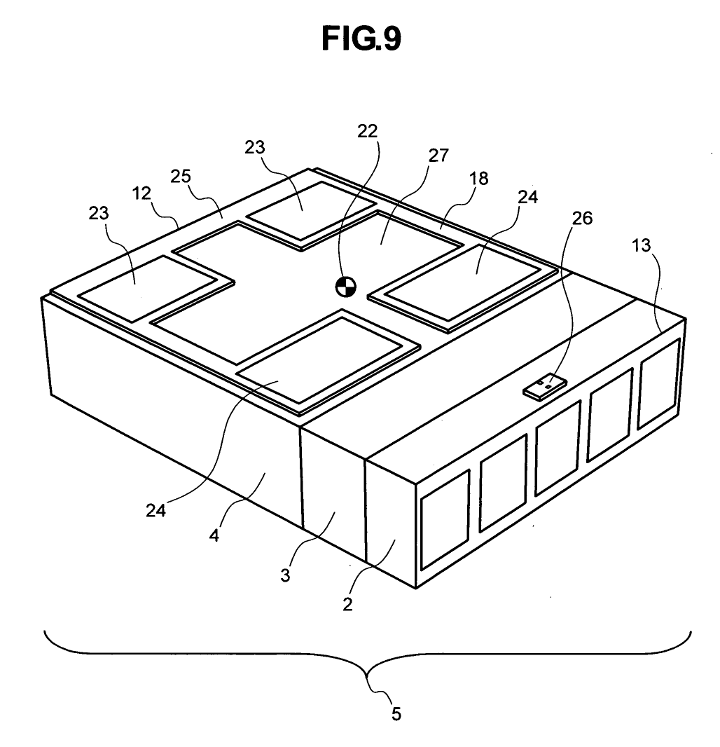

FIG. 8 is a graph showing a relationship between the amount of deformation of the piezoelectric element 3 and the flying height 18 in a case where four pads are formed on the slider base material 4 as in the present embodiment and in a case where three pads are formed in total or where two pads are formed at the interval between the leading edge 12 and the dimple position 22 and one pad is formed in the middle of the slider in the width direction thereof at the interval between the dimple position 22 and the piezoelectric element 3. The amount of deformation of the piezoelectric element 3 shown along the horizontal axis of the graph becomes positive in the direction of decreasing the flying height 18 of the write/read element.

FIG. 8 indicates that the same effect is achieved also when three pads are formed on the slider base material 4. While the trailing pad 26 formed on the air bearing surface of the magnetic head portion 2 in the present embodiment is a flat surface, the same effect may be achieved using a pad in a spherical or a spherical shape having a write element or read element exposed in a position at an apex thereof or in the vicinity of the apex.

### Embodiment 2

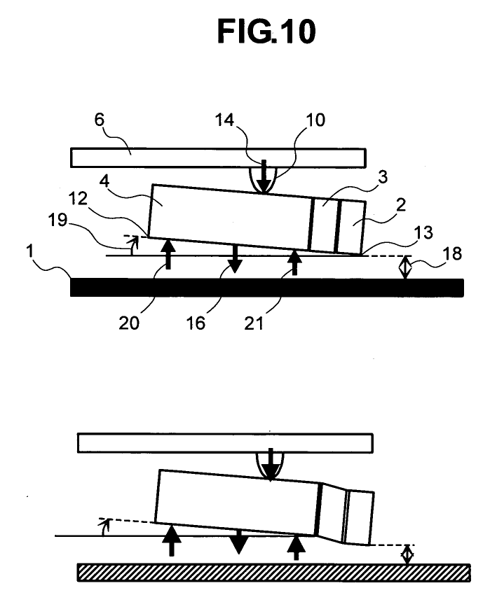

Embodiment 2 of an active slider according to the invention will now be described with reference to FIGS. 9 and 10. The embodiment described is an active slider having a negative pressure groove that is a recess for generating a negative pressure.

FIG. 9 is a perspective view showing an air bearing surface of the active slider of the present embodiment, and FIG. 10 shows balance between forces applied to the active slider of the present embodiment.

The present embodiment is similar to Embodiment 1 in that an active slider 5 is constituted by a magnetic head portion 2 having a write/read element 11, a piezoelectric element 3 subject to shear deformation, and a slider base material 4.

As shown in FIG. 10, a pressing force 14 from a dimple 10, a positive pressure 20 generated between a leading edge 12 and a dimple position 22, and a positive pressure 21 generated between the dimple position 22 and the piezoelectric element 3, and a negative pressure 16 generated at the negative pressure groove act on the slider base material 4. The attitude of the slider is determined by balance between those forces.

In the negative pressure slider of the present embodiment, the air bearing stiffness between the active slider 5 and a disk 1 may be enhanced using the negative pressure 16 to keep the attitude with higher stability. Therefore, a flying height 18 of the magnetic head portion 2 and the write/read element may be more efficiently decreased in relation to the amount of deformation of the piezoelectric element 3. The center of the generation of the negative pressure 16 is located toward the air leading side with respect to the dimple position 22. As a result, a moment which cancels a clockwise moment attributable to the positive pressure generated at a pad 23 may be generated by the negative pressure 16. It is therefore easier to suppress fluctuations of the pitch angle of the head slider even when a counterclockwise moment which must be generated by the positive pressure at the pad 24 is small.

As shown in FIG. 9, the slider base material 4 has four pads in total on the air bearing surface thereof, i.e., two pads 23 between the leading edge 12 and the dimple position 22 and two pads 24 between the dimple position 22 and the piezoelectric element 3, and positive pressures are generated by those pads. Since the negative pressure 16 is generated between the pads 23 and the pads 24, a negative pressure pocket 27 is formed, the pocket being enclosed by a step 25 on the side of the leading edge and in the width direction of the slider. Since the negative pressure is also proportionate to the surface area of the negative pressure pocket 27, the negative pressure pocket 27 is formed to extend into the interval between the pads 23 and into the interval between the pads 24 in order to achieve higher air bearing stiffness.

One trailing pad 26 including a write/read element 11 is formed on the air bearing surface of the magnetic head portion 2. The trailing pad 26 has a size that is a minimum requirement for forming the write/read element 11 in order to suppress the generation of a positive pressure just as in Embodiment 1, and no step is provided on the leading edge side of the same.

What is important is to dispose pads between the dimple position 22 and the piezoelectric element 3 also in the present embodiment, and the number of pads does not matter whether it is one or three or more.

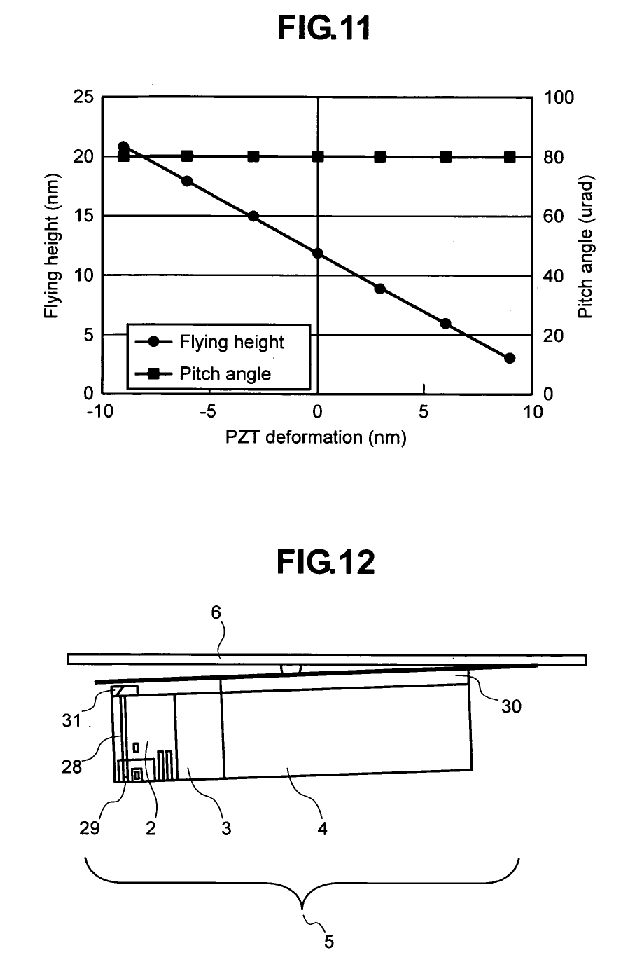

FIG. 11 is a graph showing a relationship between a flying height 18 of the write/read element provided at the trailing pad portion 26 in relation to the amount of deformation of the piezoelectric element 3 of the present embodiment and a pitch angle 19 in relation to the amount of deformation of the piezoelectric element 3. The flying height 18 is indicated by dots, and the pitch angle 19 is indicated by squares.

FIG. 11 indicates that the flying height 18 of the magnetic head portion 2 may be efficiently changed in relation to the amount of deformation of the piezoelectric element 3 in the present embodiment.

It will be understood that the deformation of the piezoelectric element 3 results in substantially no change in the pitch angle 19 and that the attitude of the slider is therefore maintained with stability.

The same effect may be achieved also in the present embodiment by providing the trailing pad 26 as a pad in a spherical or a spherical shape having a write element and a read element exposed in the vicinity of an apex thereof.

### Embodiment 3

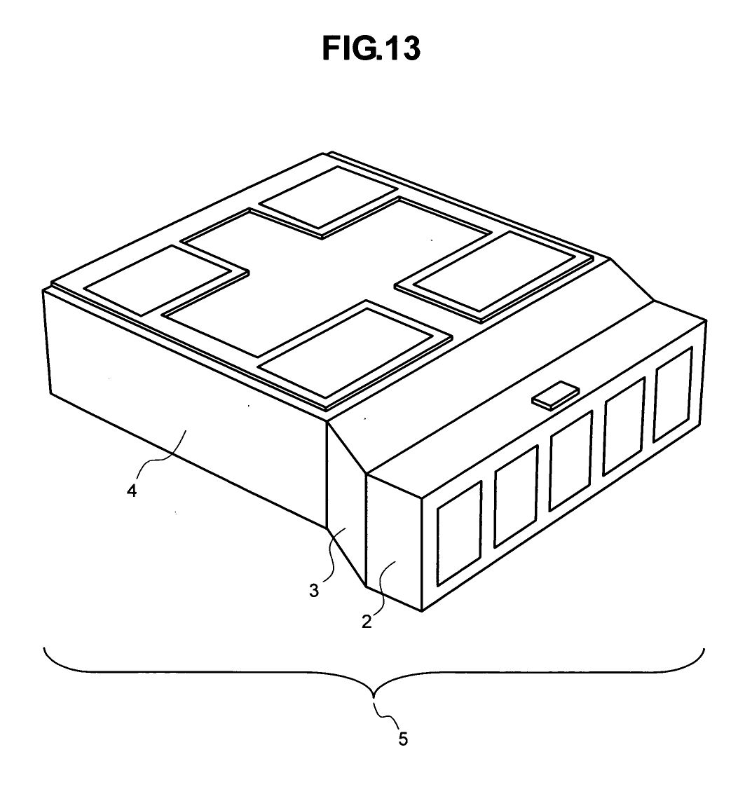

Embodiment 3 of an active slider according to the invention will now be described with reference to FIG. 12. The present embodiment is an example of the application of the invention to what is called a thermally assisted head slider.

FIG. 12 is a sectional view taken along the plane connecting the center of a leading edge 12 of an active slider 5 of the present embodiment and the center of a trailing edge 13 of the same. The active slider 5 is constituted by a magnetic head portion 2 having a waveguide 28, a near-field light generating element 29, and a write/read element 11, a piezoelectric element 3 which is subject to shear deformation, and a slider base material 4.

A laser diode (LD) 30 is provided on a surface of the slider base material 4 facing a suspension 6, and a mirror 31 is provided on a surface of the magnetic head portion 2 facing the suspension.

An air bearing surface of the slider base material 4 and an air bearing surface of the magnetic head portion 2 have configurations similar to those in the Embodiment 1 or Embodiment 2.

Laser light radiated from the LD 30 is reflected by the mirror 31, and the light reaches the near-field light generating element 29 through the waveguide 28 to be converted into near-field light which heats recording bits on a surface of a disk 1.

In the active head slider 5 of the present embodiment, the flying height of the head portion 2 having the near-field light generating element 29 may be easily controlled by deforming the piezoelectric material 3, and high stability of flight is also achieved. Therefore, thermally assisted magnetic recording may be easily controlled when the active slider is used, which allows the recording density of a magnetic disk apparatus to be further improved.

### Embodiment 4

Embodiment 4 of an active slider according to the invention will now be described with reference to FIG. 13.

The active slider 5 is constituted by a magnetic head portion 2 including a write element and a read element, a piezoelectric material 3 which is subject to shear deformation, and a slider base material 4. The piezoelectric element 3 of the present embodiment is disposed such that shear deformation of the same causes the write/read element of the magnetic head portion 2 to move in the direction of the width of a track on a disk.

An air bearing surface of the slider base material 4 and an air bearing surface of the magnetic head portion 2 have configurations similar to the configurations in any of the above-described embodiments.

### Embodiment 5

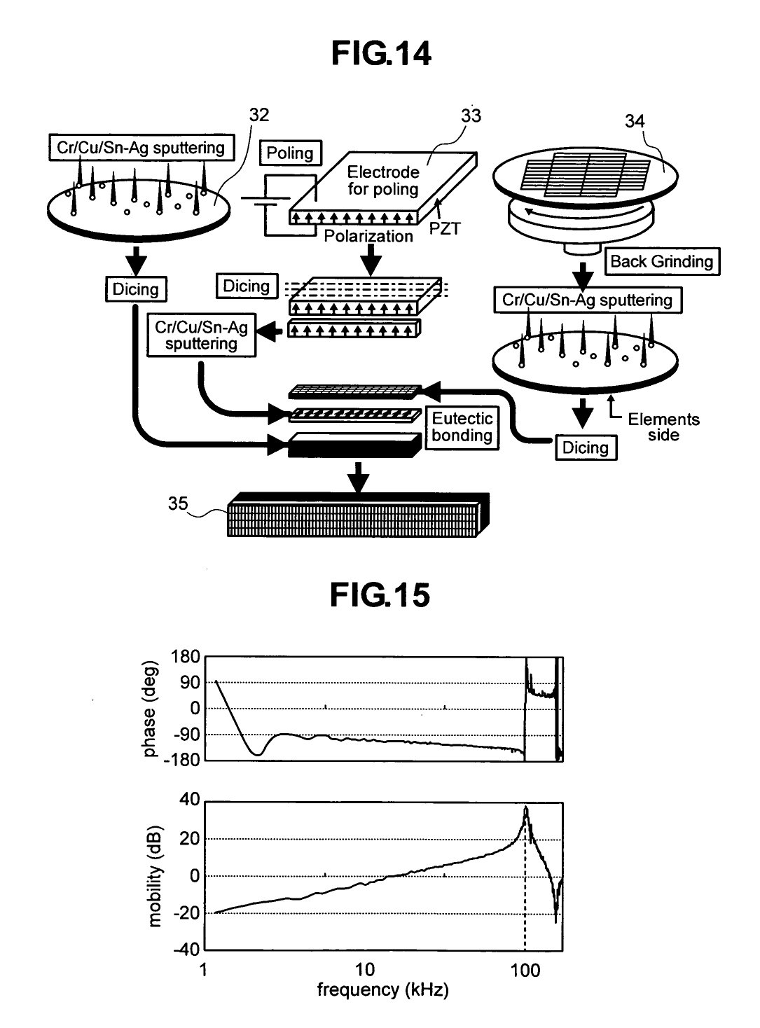

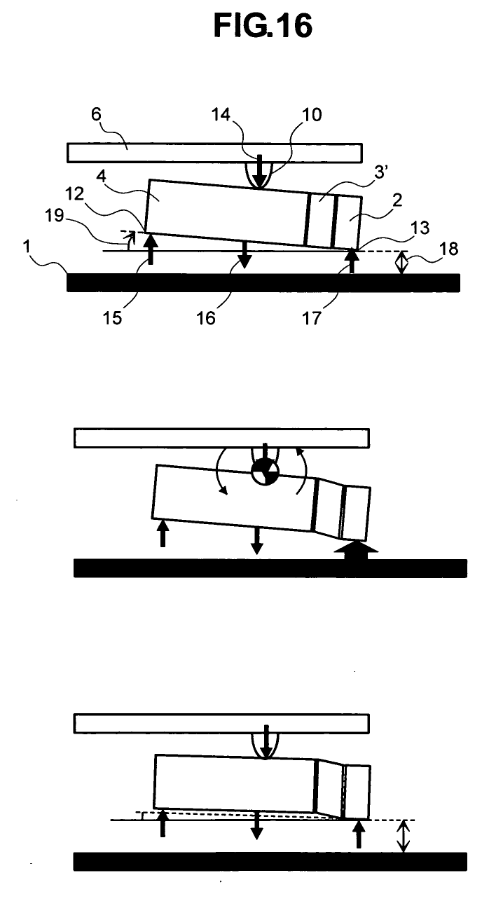

An embodiment of a method of manufacturing an active head slider according to the invention will now be described with reference to FIG. 14. The active slider according to the invention is constituted by three portions, i.e., a magnetic head portion 2, a piezoelectric element 3, and a slider base material 4, and they are fabricated in parallel at a first part of a manufacturing process.

A part to become a slider base material is obtained by depositing metals such as Cr/Cu/Sn—Ag on an AlTiC wafer 32 using sputtering and cutting the wafer into a plurality of plates including parts to become slider base materials. Cr/Cu/Sn—Ag represents a layered structure formed by stacking a Cr layer, a Cu layer, and a layer of a Sn—Ag alloy which are listed in the order of closeness to the wafer. The structure is formed by first performing sputtering with a target of Cr kept open, performing sputtering with a target of Cu kept open, and finally performing sputtering with targets of Sn and Ag kept open. Cr has the function of maintaining adhesion to the AlTiC wafer 32. Cu is used as a conductor of an electrode after a head slider is formed as described later taking advantage of the low resistance of the same. Ag—Sn has the function of eutectic bonding which will be also described later. Although an AltiC wafer is used in the present embodiment, a Si wafer may alternatively be used.

A part to become a piezoelectric element 3 is obtained by polishing a piezoelectric material 33 after polarizing the same, removing the electrodes used for polarization, and cutting the material into a plate with the thickness of the same adjusted. After the cutting, Cr/Cu/Sn—Ag structures are sputter-deposited on a cut surface which is to be bonded to a slider base material and a surface which is to be bonded to a magnetic head just as done on the AlTiC wafer 32. The sputter-deposited surfaces are in parallel with the polarization direction. The sputter-deposited Cr/Cu/Sn—Ag structures serve as electrodes for deforming the piezoelectric element. Apart to become a magnetic head portion 2 is obtained by forming a write/read element on an Al₂O₃ wafer 34 using the same process as existing ones and grinding a back surface of the wafer thereafter. A Cr/Cu/Sn—Ag structure is similarly sputter-deposited on the ground surface, and the wafer is thereafter cut into plates. Although an Al₂O₃ wafer is used in the present embodiment, an AlTiC wafer or a Si wafer may alternatively be used.

Next, the plate-like piezoelectric element is disposed such that it is sandwiched by the plate-like slider base material and the plate-like magnetic head. Then, a temperature and/or a pressure is applied to bond them using eutectic bonding of Sn—Ag. In general, a depolarizing temperature at which a piezoelectric element starts to become depolarized is considered to be about ⅔ of a Curie temperature at which complete depolarization takes place. Since the piezoelectric element used in the present embodiment has a Curie temperature of 330° C., the bonding surface was heated up to 220° C. The maximum processing temperature of a magnetic head is normally about 160° C., and the magnetic head is broken down when a higher temperature is applied. For this reason, an element surface of the magnetic head, i.e., a surface opposite to the bonding surface must be cooled during bonding. After a row-stack 35 is formed by bonding the slider base material, piezoelectric element, and magnetic head in the form of plates, processes similar to existing slider manufacturing processes are performed, including a wrapping, cutting a row-bar from the row-stack 35, a wrapping to provide tip of write pole, coating with a protective film, and the formation of pads on air bearing surfaces. Finally, cutting is performed to obtain individual sliders.

Referring to the piezoelectric element, polarization may be carried out in advance by forming electrodes for polarization on both sides of the piezoelectric material in the form of a plate. After the material is cut into a piezoelectric element, a metal may be sputtered onto cut surfaces to use the surfaces as driving electrodes. Thus, driving electrodes may be easily provided in a direction orthogonal to the polarization direction.

It is efficient to bond a slider base material, a piezoelectric element, and a magnetic head when they are in the form of a wafer. However, a voltage as high as 400 kV is required to polarize a piezoelectric element in an in-plane direction thereof when the element has a size on the order of, for example, a 6-inch wafer. In the case of a wide bonding surface, it is difficult to bond the entire surface uniformly because of the influence of a warp or the like.

In the future, studies must be made on batch processes in which the sol-gel method or sputtering deposition method may be used to form thinner piezoelectric layers and to reduce the size of a deformed portion and in which piezoelectric layers may therefore be collectively formed on an AlTiC wafer and magnetic heads may be formed on the layers using thin film processes. However, the piezoelectric constant of a piezoelectric material formed using the sol-gen method or sputtering method is presently very much smaller than the piezoelectric constant of a bulk piezoelectric element, and a required amount of deformation cannot be obtained. Under the circumference, the present embodiment employs a method in which bulk piezoelectric elements are used and bonded to slider base materials and magnetic heads.

In the present embodiment, the magnetic head portion 2, the piezoelectric element 3, and the slider base material 4 are bonded using eutectic bonding of Sn—Ag. However, when the heat resistance of the magnetic head is considered, a bonding method involving no heating such as surface activated bonding may alternatively be used.

Finally, FIG. 15 shows frequency response function of the magnetic head portion 2 at the time of deformation of the piezoelectric element 3 achieved in each of the above-described embodiments. A 1st resonant frequency of 100 kHz has been achieved. The 1st resonant frequency may be increased beyond 100 kHz by reducing the thickness of the magnetic head portion 2 and the piezoelectric element 3. A waviness of a disk on the order of the length of the slider may be followed up when the slider has response of about 40 kHz or more. Therefore, the slider of each embodiment of the invention may sufficiently follow up such a waviness of a disk.

Since the magnetic head is the only part which is moved by the deformation of the piezoelectric element 3 as thus described, the active slider may be designed to have a high resonant frequency. This allows disturbance of a high bandwidth to be compressed, thereby enabling highly accurate positioning. Since the mass of the magnetic head portion 2 is one-tenth or less of the mass of the slider base material 4, a reaction force generated by the movement of the magnetic head portion 2 is small.

In the active slider of the present embodiment, only a piezoelectric element for moving the magnetic head in a track positioning direction is provided. Alternatively, a piezoelectric material 3 for moving the magnetic head in the direction of the flying height thereof may be provided in addition as in the above-described embodiments. Further, in addition to the piezoelectric element 3, the piezoelectric longitudinal distortion effect or piezoelectric lateral distortion effect may be provided to allow the magnetic head portion 2 to be moved in the circumferential direction of a track. As a result, not only the flying height adjustment but also highly accurate positioning and jitter compensation may be made using a single active slider, which will contribute greatly to increase in the recording density of magnetic disk apparatus.

The use of the above-described structures make it possible to provide a disk apparatus which achieves a high recording density by accurately positioning a magnetic head on a data track.

A more specific example of the piezoelectric element 3 used in the above description is a PZT/Si unimorph type electrostrictive element. However, a magnetostrictive element which is distorted by a magnetic field may alternatively be used as the actuator. Such deforming elements may sufficiently follow up a waviness of a magnetic disk because they are quicker in response than elements deformed using heat.

Where a waviness of a magnetic disk is not a problem, even an actuator having low response may efficiently cause a change in a flying height when the actuator is deformed, and a slider may be prevented from becoming unstable in attitude because of a movement of a magnetic head when such an actuator is deformed.

What is claimed is:

1. A head slider comprising:
a slider base material which receives a pre-load from a suspension;
a deforming element coupled to the slider base material;
a head portion coupled to the slider base material through the deforming element; and
a pad generating a positive pressure on an air bearing surface of the slider base material which is located toward the deforming element with respect to the position receiving the pre-load.

2. A head slider according to claim 1, further comprising a second pad for a write/read element,
wherein a moment of a pressure generated by the second pad and acting around the position receiving the load is smaller than a moment of the pressure generated by the pad and acting around the position receiving the pre-load.

3. A head slider according to claim 1, further comprising a second pad for a write/read element provided at the head portion,
wherein a step formed on an air leading side of the second pad is 0.25 μm or more.

4. A head slider according to claim 3, wherein the second pad is formed with a spherical or curved surface and wherein the write/read element is formed to reside on the apex of the pad.

5. A head slider according to claim 1, further comprising a negative pressure groove provided on the air bearing surface.

6. A head slider according to claim 5, wherein the pressure center of a negative pressure generated by the negative pressure groove is located toward the air leading side with respect to the position receiving the load.

7. A head slider according to claim 1, further comprising a third pad which is located toward the air leading side with respect to the pad on the air bearing surface of the slider base material.

8. A head slider according to claim 1, wherein the pad is located in the middle of the head slider when viewed in the direction of a shorter side of the same.

9. A head slider comprising:
a head portion having an element for writing and reading information on and from a recording medium;
a deforming element located on an air leading side of the head portion; and
a slider base material located on the air leading side of the deforming element, the slider comprising:
a first positive pressure generating surface provided on an air bearing surface which is located toward the air leading side with respect to the position at ⅓ of the entire length of the head slider from the air leading side; and
a second positive pressure generating surface provided on the air bearing surface which is located toward the air leading side with respect to the position at ⅓ of the entire length of the head slider and which is located toward the air leading side with respect to the deforming element.

10. A head slider according to claim 9, further comprising a third positive pressure generating surface for the write/read element, wherein a step having a depth of 0.25 μm is provided on an air leading side of the third positive pressure generating surface.

11. A head slider according to claim 9, further comprising a negative pressure groove located toward the air leading side with respect to the second positive pressure generating surface, wherein the pressure center of a negative pressure generated by the negative pressure groove is located toward the air leading side than the position at ½ of the entire length of the head slider.

12. A head slider according to claim 9, further comprising a negative pressure groove located toward the air leading side with respect to the second positive pressure generating surface, wherein the pressure center of a negative pressure generated by the negative pressure groove is located toward the air leading side with respect to the position at ⅓ of the entire length of the head slider.

13. A head slider according to claim 9, wherein the deforming element causes the write/read element to move relative to the slider base material toward the recording medium.

14. A head slider according to claim 9, wherein the deforming element causes the write/read element to move relative to the slider base material in the direction of the width of a track of the recording medium.

15. A head slider according to claim 9, wherein the deforming element causes the write/read element to move relative to the slider base material in the circumferential direction of a track of the recording medium.

16. A method of manufacturing a head slider comprising the steps of:
vacuum-depositing a metal on a surface of a first wafer;
forming a write/read element on a surface of a second wafer;
vacuum-depositing a metal on a surface of the second wafer opposite to the surface on which the write/read element is formed;
vacuum-depositing a metal on both surfaces of a plate material to serve as a deforming element;
bonding the first wafer and the second wafer with the plate material sandwiched between the surfaces thereof on which the metals are vacuum-deposited; and
cutting the bonded member into a head slider.

17. A method of manufacturing a head slider according to claim 16, wherein eutectic bonding of the vacuum-deposited metal is used to bond the first wafer and the plate material and to bond the plate material and the second wafer.

18. A method of manufacturing a head slider according to claim 16, wherein the bonding step includes application of pressure/heat to the bonded surfaces.

19. A method of manufacturing a head slider according to claim 16, wherein the vacuum-deposited metals form an electrode of the deforming element.

20. A method of manufacturing a head slider according to claim 16, wherein the first wafer is an AlTiC wafer; the second wafer is an Al₂O₃ wafer; the plate material is a piezoelectric material; and the meal is Cr/Cu/Sn—Ag.
